(19) United States
(12) Patent Application Publication
(10) Pub. No.: US 2012/0029143 A1
(43) Pub. Date: Feb. 2, 2012

(54) SILANE COATING MATERIAL AND A PROCESS TO PRODUCE SILANE COATING

(75) Inventors: Stefan SEPEUR, Wadgassen (DE); Nora LARYEA, Saarbruecken (DE); Carolin THURN, Wadgassen (DE); Gerd SCHLICK, Freyming-Merlebach (FR)

(73) Assignee: NANO-X GMBH, Saarbruecken (DE)

(21) Appl. No.: 13/236,912

(22) Filed: Sep. 20, 2011

Related U.S. Application Data
(63) Continuation of application No. 12/311,064, filed on May 26, 2009.

(30) Foreign Application Priority Data
Sep. 18, 2006 (DE) 10 2006 044 310.1

(51) Int. Cl. C09D 183/08; C09D 183/06; B05D 3/06; C08J 7/04; B05D 3/10; B05D 3/12

(52) U.S. Cl. 524/588; 427/387; 427/256; 427/255.6; 427/358; 427/287; 427/288; 427/255.14; 427/510; 427/515

(57) ABSTRACT

A process to produce a silane coating includes charging one or several silanes, which are not or only minimally pre-condensed, with a reactant and the thus created coating material is applied onto a substrate and then hardened. Surprisingly it has been shown that, through the reaction involving higher-molecular and only slightly pre-cross-linked silanes with a suitable reactant, a new class of coating materials can be created. The approach is advantageous insofar as restrictions with respect to pot time no longer exist and, in addition, better features of the coating material are obtained, especially a high scratch-resistance.

### CROSS REFERENCE TO RELATED APPLICATIONS

This application is a continuation and claims priority under 35 U.S.C. §120 of U.S. patent application Ser. No. 12/311,064 filed on May 26, 2009, which application claims the benefit as a National Stage entry of a PCT application pursuant to 35 U.S.C. §371 of International Application No. PCT/DE2007/001602 filed on Sep. 10, 2007, published in the German language, which in turn claims priority under 35 U.S.C. §119 of German Application No. 10 2006 044 310.1 filed on Sep. 18, 2006, the disclosures of each of which are incorporated by reference.

The invention relates to a silane coating material and a process to produce silane coating.

There are known silane coatings which are produced from silicone resins. These involve pre-condensing monomers, such as dimethyl siloxane or otherwise organically modified homologous species, until there are resins of high molecular weight. These can then be hardened with the usual commercial starters. Applications of such systems include coating, building protective agents, sealants, etc.

To maintain these systems in a coatable form and to prevent gelation, silanes are generally utilized with two organically modified side chains.

These coating systems are highly temperature resistant, but usually only demonstrate moderate abrasion resistance.

Three- and fourfold cross-linkable silanes are made into a processible form in the sol-gel process. With this process silanes, such as tetraethoxysilane (TEOS) or methyltriethoxysilane (MTEOS), but also organically modified silanes, such as glycidoxypropyltriethoxysilane (GPTES, Glyeo) or methacrylpropyltrimethoxysilane (MPTS) etc., are hydrolized and pre-condensed in the presence of a catalyst. This creates a coatable sol, which can be applied to a surface as coating following application and hardening.

This results in additional organic linking and the coatings are generally scratch-resistant as well as highly cross-linkable and resistant against chemicals.

However, during the synthesis low-molecular alcohols, such as methanol and ethanol, are created which exhibit a low flash point and are difficult to remove. As described in DE 198 16 136 A1, these can be removed or separated by phase separation, as described in DE 100 63 519 A1. Another issue is the limited pot life resulting from the uncontrolled continuation of the condensation reactions.

The purpose of the invention is thus to create a silane coating production process according to the preamble, in which the disadvantages described above are avoided.

According to the invention this objective is accomplished with a process to produce a silane coating where one or several non-precondensed silanes with a molecular mass greater than 300 undergo an organic linking reaction with homologous or non-homologous silanes or with organic monomers, oligomers or polymers, charged with a reactant consisting of 0.5 to 50 weight by percent Lewis acids and the thus produced coating material is applied onto a substrate and then hardened.

Surprisingly it has been shown that through the reaction involving higher-molecular and only slightly pre-cross-linked silanes with a suitable reactant a new class of coating materials can be created. According to the current state of the art, silanes are processed in sol-gel processes, where pre-condensed species are assumed. The approach according to the invention, in which a pre-condensation reaction is mostly or completely avoided, is advantageous in that there are no restrictions with respect to pot time and, additionally, better features of the coating material are obtained, particularly a high scratch-resistance.

The organic cross linking reaction is understood as an organic linking of two silanes or between silanes and organic molecules via the organic functions, producing silanes of greater molecular weight.

According to the invention, the molecular mass of the silane(s) should be greater than 500 and most preferably greater than 1,000.

It is important for the molecular weight of the silanes to be high so that the reaction can be started on a surface without the uncondensed silanes evaporating.

This invention includes that the silane(s) exhibit polarized groups in organic side chains which are suitable for the formation of hydrogen bonds.

Also, according to the invention, the vapor pressure of the silane(s) is below 2, preferably below 1 and most preferably lower than 0.5 hPa at 20° C.

It is possible, for example, that the silane(s) are isocyanosilanes pre-cross linked with diols or polyols.

In this context, the organic molecular mass is preferably greater than the inorganic.

As silanes, especially the following can be considered: 3-aminopropyltriethoxysilane, aminoethylaminpropyltrimethoxysilane, aminoethylaminopropyltrimethoxysilane, aminoethylaminopropylsilane, 3 -aminopropyltrimethoxysilane, N-(2-aminoethyle)-3-aminopropyltrimethoxysilane, N-(2-aminoethyl)-3-aminopropylmethyldimethoxysilane, N-(2-aminoethyl)-3-aminopropylmethyldimethoxysilane, N-cyclohexyl-3 -aminopropyl-trimethoxysilane, benzylaminoethylaminopropyltrimethoxysilane, vinylbenzylamino-ethylaminopropyltrimethoxysilane, vinyltrimethoxysilane, vinyltriethoxysilane, vinyldimethoxymethylsilane, vinyl(tris)methoxyethoxy)silane, vinylmethoxymethylsilane, vinyltris(2-methoxyethoxy)silane, vinyltriacetoxysilane, chloropropyltrimethoxysilane, 3-glycidoxypropyltrimethoxysilane, 3-glycidoxypropyltriethoxysilane glycidoxypropylmethyldiethoxysilane, mercaptopropyl-trimethoxysilane, bis-triethoxysilylpropyldisulfidosilane, bis-triethoxysilyl-propyldisulfidosilane, bis-triethoxysilylpropyltetroasulfidosilane, N-cyclohexylaminomethylmethyldieethoxysilane, n-cyclohexylaminomethyltriethoxysilane, n-phenylaminomethyltrimethoxysilane, (methacryloxymethyl)methyldimethoxysilane, methacryl-oxymethyltrimethoxysilane, (methacryloxymethyl)methyldiethoxysilane, methacryloxymethyl-triethoxysilane, 3-methacryloxypropyltrimethoxysilane, 3-methacryloxypropyltrimethoxysilane, 3-methacryloxypropyltriacetoxysilane, (isocyanatomethyl)methyldimethoxysilane, 3-isocyanatopropyltrimethoxysilane, 3-trimethoxysilylmethyl-O-methylcarbamat, n-dimethoxy-(methyl)silylmethyl-O-methyl-carbamat, 3-(triethoxysilyl)propyl succinic anhydride.

In the context of this invention the water content should be a maximum of 5%, preferably 1% and most preferably the reaction should occur without the presence of water.

Air humidity generally does not interfere with the reaction.

Furthermore, according to the design, the silane(s) should be pre-cross-linked at a maximum of 5%, preferably 1% and most preferably not inorganically pre-cross-linked.

It is also part of the invention that up to 20 weight per cent Lewis acids or Lewis bases be utilized as reactants, especially in the form of transition metal complexes, salts or particles, preferably micro- or nano-particles.

In this context the transition metal complexes, salts or particles should preferably be titanium, aluminum, tin or zirconium complexes.

It can also be provided that particles, especially micro-, sub-micro- or nano-particles be added as fillers.

A design of the invention involves the addition of solvents, especially alcohol, acetates, ether or reacting diluents.

The invention also includes the addition of dulling substances, linkage dispersing agents, antifoaming agents, waxes, biocides, preservative agents or pigments.

A further development of the invention consists of the wet-chemical application of the coating material onto a substrate, particularly by spraying, immersion, flooding, rolling, painting or otherwise by vacuum evaporation.

According to the invention the substrate is made of metal, synthetic, ceramic, lacquer, textile or a natural substance, such as wood or leather, glass, mineral substances or composite materials.

Additionally, the invention entails that the coating material is hardened after application at temperatures from room temperature up to 1,200° C., preferably from room temperature up to 250° C., with the hardening preferably being done thermally, by microwave radiation or UV radiation.

Silane coating, produced by a process according to the invention, is also included in the invention.

Furthermore, scratch-resistance, anti-corrosion, easy-to-clean, anti-fingerprint, anti-reflex, anti-fogging, scaling protection, diffusion barrier, radiation protection coating or as self-cleaning, anti-bacterial, anti-microbial, tribological and hydrophilic coating is part of the invention.

The following embodiments provide further details about the invention.

### EMBODIMENT 1

11.8 g hexanediole are warmed with 49.5 g ICTES (isocyanatopropyltriethoxysilane) while stirring to 50° C. and charged with 0.1 g dibutyltin dilaurate. Stirring continues for 30 min. at 50° C. followed by cooling down to room temperature.

5 g adduct (see above) is dissolved in 10 g 1-methoxy-2-propanol and charged with 0.2 g aluminium acetylacetonate.

After application (e.g. flooding) onto a polycarbonate panel, hardening is performed for 50 min. at 120° C. in a circulating air oven.

The resulting coating exhibits excellent scratch-resistance.

### EMBODIMENT 2

30.0 g desmophen 1145 is warmed with 4.3 g ICTES (isocyanatopropyltriethoxysilane) while stirring to 50° C. and charged with 0.15 g dibutyltin dilaurate. Stirring continues for 1 h at 50 ° C. followed by cooling down to room temperature.

10 g resultant (see above) is dissolved in 8 g 1-methoxy-2-propanol and charged with 0.1 g aluminium acetylacetonate.

Sheet iron is coated with the resulting coating solution using spray application and then hardened at 150° C. for 60 min. in a circulating air oven.

The layers exhibit high scratch and corrosion resistance.

### EMBODIMENT 3

22.1 g aminopropyltriethoxysilane is stirred with 27.8 g glycidoxypropyltriethoxysilane at 45° C. and left at that temperature for 45 min.

10 g of the reactive mixture is dissolved in 12 g isopropanol and charged with 0.3 g acetyl aceton.

After flooding on aluminum plates the coats are hardened at 120° C. for 20 min. in a circulating air oven.

The coats exhibit high scratch and corrosion resistance.

### EMBODIMENT 4

24.8 g 3-methoxypropyltriethoxysilane is dissolved in 12 g 1-methoxy-2-propanol and charged with 2.5 g ebecryl 1259 and 2.0 g desmodur N 3300 and tempered at 40° C. for 2 h. Then 0.24 g zirconium acetylacetonate is added to the mixture. The mixture is applied to a PMMA panel by flooding and irradiated with approx. 2.5 J/cm² with a Hg medium pressure lamp and subsequently tempered for 2 h at 80° C.

The layers exhibit high scratch and abrasion resistance and/or chemical resistance to acids and bases.

1. Process to produce a silane coating, wherein a silane selected from the group consisting of 3-aminopropyltriethoxysilane, aminoethylaminopropyltrimethoxysilane, aminoethylaminopropyltrimethoxysilane, aminoethylaminopropylsilane, 3-aminopropyltrimethoxysilane, N-(2-aminoethyl)-3-aminopropyltrimethoxysilane, N-(2-aminoethyl)-3-aminopropylmethyldimethoxysilane, N-(2-aminoethyl)-3-aminopropylmethyldimethoxysilane, N-cyclohexyl-3-aminopropyl-trimethoxysilane, benzylaminoethylaminopropyltrimethoxysilane, vinylbenzylaminoethylaminopropyhrimethoxysilane, vinyltrimethoxysilane, vinyltriethoxysilane, vinyldimethoxymethylsilane, vinyl(tris)methoxyethoxy)silane, vinylmethoxymethylsilane, vinyltris(2-methoxyethoxy)silane, vinyltriacetoxysilane, 3-glycidoxypropyltrimethoxysilane, 3-glycidoxypropyltriethoxysilane glycidoxypropylmethyldiethoxysilane, mercaptopropyltrimethoxysilane, bis-triethoxysilylpropyldisulfidosilane, bis triethoxysilylpropyldisulfidosilane, bis-triethoxysiiylpropyltetroasulfidosilane, tetraethoxysilane, N-cyclohexylaminomethylmethyldieethoxysilane, N-cyclohexylaminomethyltriethoxysilane, N-phenylaminomethyltrimethoxysilane, (methacryloxymethyl)methyldimethoxysilane, methacryloxymethyltrimethoxysilane, (methacryloxymethyl)methyldiethoxysilane, methacryloxymethyltriethoxysilane, 3-methacryloxypropyltrimethoxysilane, 3-methacryloxypropyltrimethoxysilane, 3-methacryloxypropyltriacetoxysilane, (isocyanatomethyl)methyld methoxysi lane, 3-trimethoxysilylmethyl-O-methylcarbamat, N-dimethoxy-(methyl)silymethyl-O-methylcarbamat and 3-(triethoxysilyl)propyl succinic anhydride, which is pre-condensed at a maximum of 5%, undergoes an organic cross-linking reaction with organic monomers, oligomers or polymers and the thus resulting coating material is applied onto a substrate and then hardened.

2. Process according to claim 1, wherein the molecular mass of the silane is greater than 200, in particular greater than 300, preferably greater than 500 and most preferably greater than 1,000.

3. Process according to claim 2, wherein the silane exhibits polarized groups in organic side chains which are suitable for the formation of hydrogen bonds.

4. Process according to claim 1, wherein the vapor pressure of the silane is less than 2, preferably less than 1 and most preferably less than 0.5 hPa at 20° C.

5. Process according to claim 1, wherein the organic molecular mass is greater than the inorganic.

6. Process according to claim 1, wherein the water content is a maximum of 5%, preferably a maximum of 1% and most preferably the reaction occurs without the presence of any water.

7. Process according to claim 1, wherein the silane is pre-cross linked at a maximum of 1% and most preferably is not inorganically pre-cross linked.

8. Process according to claim 1, wherein as reactants up to 50%, preferably 0.5 to 20 weight per cent Lewis acids or Lewis bases are used, especially in the form of transition metal complexes, salts or particles, preferably micro- or nano-particles.

9. Process according to claim 8, wherein the transition metal complexes, salts or particles are titanium, aluminum, tin or zirconium complexes.

10. Process according to claim 1, wherein particles, especially micro-, submicro- or nano-particles, are added as fillers.

11. Process according to claim 1, wherein solvents, especially alcohol, acetates, ether or reacting diluents are added.

12. Process according to claim 1, wherein dulling substances, linkage dispersing agents, antifoaming agents, waxes, biocides, preservative agents or pigments are added.

13. Process according to claim 1, wherein the coating material is applied onto the substrate by wet-chemical application, particularly by spraying, immersion, flooding, rolling, painting, printing, throwing, blade coating or by vacuum evaporation.

14. Process according to claim 13, wherein the substrate is made of metal, synthetic, ceramic, lacquer, textile or a natural substance, such as wood or leather, glass, mineral substances or composite materials.

15. Process according to claim 13, wherein the coating material is hardened after application at temperatures from room temperature up to 1,200° C., preferably from room temperature up to 250° C., where the hardening is preferably done thermally, with microwave radiation or UV radiation.

16. Silane coating produced by a process according to claim 1.

17. Use of coating according to claim 16 as scratch-resistance, anti-corrosion, easy-to-clean, anti-fingerprint, anti-reflex, anti-fogging, scaling protection, diffusion barrier, radiation protection coating or as self-cleaning, anti-bacterial, antimicrobial, tribological and hydrophilic coating.
